(19) United States
(12) Patent Application Publication
(10) Pub. No.: US 2003/0193980 A1
(43) Pub. Date: Oct. 16, 2003

(54) Device and method for invisible road illumination and imaging using preliminary pulses

(76) Inventor: Oleg Matveev, Gainesville, FL (US)

Correspondence Address: AKERMAN SENTERFITT, P.O. BOX 3188, WEST PALM BEACH, FL, 33402-3188, US

(21) Appl. No.: 10/448,173

(22) Filed: May 28, 2003

Related U.S. Application Data
(63) Continuation-in-part of application No. 10/157,359, filed on May 28, 2002.
(60) Provisional application No. 60/295,699, filed on Jun. 5, 2001.

(51) Int. Cl. H01S 3/09

(52) U.S. Cl. 372/69

(57) ABSTRACT

A reduced glare imaging system for motor vehicles. The reduced glare imaging system includes at least one imaging device for receiving images. The imaging device receives light signals for image processing in a first operational state and does not receive the light signals for image processing in a second operational state. An electromagnetic detection unit is provided for detecting electromagnetic signals generated by a second imaging system. A synchronization unit is also provided for signaling the imaging device to change operational states in response to a detection of the electromagnetic signals generated by the second imaging system.

### CROSS-REFERENCE TO RELATED APPLICATIONS

The present application is a continuation-in-part of U.S. patent application Ser. No. 10/157,359 entitled Device and Method for Vehicular Invisible Road Illumination and Imaging, filed May 28, 2002, which claims the priority of U.S. provisional patent application No. 60/295,699, filed Jun. 5, 2001.

### BACKGROUND

1. Field of the Invention

The present invention relates to a reduced glare imaging system for motor vehicles, and more particularly to roadway illumination systems which do not cause glare for oncoming drivers.

2. Discussion of the Related Art

Both the human and economic costs resulting from automobile accidents are staggering. In 1994 alone the economic cost of automobile accidents was more than $150.5 billion. By 2000 the annual cost had skyrocketed to $230.6 billion, and the cost continues to rise. Tragically, the toll on human life is even more devastating, especially at night Nighttime driving represents only about 28 percent of total driving, yet it accounts for about 55 percent of all traffic fatalities. On a per mile basis, driving at night is more than three times as likely to result in a fatality as compared to driving during daylight. In 1996 alone there were more than 18,000 fatal nighttime automobile accidents, including approximately 3,500 pedestrian fatalities and 368 bicyclist fatalities. Significantly, nighttime pedestrian fatalities represent about two-thirds of all pedestrian fatalities caused by automobiles. While several factors affect these statistics, limited vision is one of the main reasons behind the high rate of automobile accidents and fatalities. In particular, a large percentage of nighttime car accidents occur either due to inadequate illumination of the roadway or due to drivers being blinded by oncoming cars.

Several scientific conceptions are currently under different stages of development to improve driving safety at night. One concept uses ultra-violet (UV) light, which is invisible to oncoming drivers, to supplement an automobile's high beam headlights. This method is described in U.S. Pat. No. 4,970,628 to Bergkvist. Another automobile headlight concept using UV light is disclosed in U.S. Pat. No. 5,255,163 to Neumann. Neumann discloses a headlight for a motor vehicle which includes a gas discharge lamp as a light source emitting both UV and visible light.

UV road illumination has several substantial drawbacks, however. Notably, UV light does not adequately illuminate many obstacles on the road. Hence, if a driver becomes too reliant on UV lamps, the driver may miss important imaging information, which increases the probability of car accidents at night. Fluorescing materials which improve illumination in the UV spectrum can be installed into roads, but in the U.S. alone the expense of installing the fluorescing materials onto all roadways will run into the billions of dollars. Further, many natural objects will still be difficult to see if only UV illumination is used to illuminate a roadway. Thus, even if UV road illumination is implemented into vehicles, low beam headlights will probably still be used to insure adequate illumination. Low beam headlights, however, can produce glare for oncoming drivers.

UV light also can be hazardous to pedestrians and oncoming drivers since UV light emanating from an automobile's headlights is likely be brighter than ambient UV light received from the sun on a typical summer afternoon. Since pedestrians and oncoming drivers will not see the UV light, they likely will not close their eyes as they would if they were looking directly at the sun. Notably, the eye of a pedestrian is likely to be opened wider during the night as compared to the day. Moreover, the pupil of an eye is one to two orders of magnitude larger at night. Accordingly, pedestrians and oncoming drivers are likely to receive a total exposure of UV light which can be damaging to their eyes.

Infrared (IR) thermal imaging using light having a wavelength of approximately 9-10 μm is another illumination concept currently being developed. In fact, IR thermal imaging cameras are commercially available on certain automobiles. Thermal imaging has several drawbacks, however. Significantly, since the 9-10 μm wavelength is 20 times longer than visible radiation, the spatial resolution of an image generated by IR thermal imaging is 20 times worse than the resolution obtained using visible light. In particular, an IR thermal image has a resolution which is typically only 76800 pixels (320×240), two orders of magnitude less than the resolution of modern charged coupled device (CCD) cameras, or the human eye.

In addition to the resolution limitations of IR thermal imaging, road image contrast, sharpness and brightness of an IR thermal imaging system is dependent on ambient temperature. Objects on a road which have equal temperature, for example tires, trees or stones on the road, might not be distinguishable. For example, if an ambient temperature is close to the temperature of a human body (36° C.), humans will not be seen or will be seen with poorly distinguishable contrast. If the ambient temperature is too cold, for example −25° C., the brightness and the contrast of the IR thermal images might be two to three times worse in comparison to images taken with a warmer ambient temperature, for instance +25° C. Another issue with IR thermal imaging is that an image of an object which is taken during a rain storm, or immediately thereafter, will be different than an image of the same object which is taken when ambient conditions are dry.

A number of other active and semi-active night viewing devices are known. Such systems often use a target illumination system which is pulsed, such as a pulsed laser, and an imaging system. The imaging systems are sometimes gated or provided with a spectrally selective filter in an attempt to filter out visible light from oncoming automobiles. However, current systems using these techniques are not able to block enough visible light from oncoming vehicle headlights to provide high resolution images. For instance, the period between laser pulses is not adequate to provide a precise image. Moreover, spectral filters currently used are not sufficiently selective to distinguish scattered light from light generated by headlights of oncoming vehicles. Further, the energy required for generating the illumination pulses is quite high in order to have an acceptable signal to noise ratio.

### SUMMARY OF THE INVENTION

The present invention relates to a reduced glare imaging system for motor vehicles. The reduced glare imaging system includes at least one imaging device for receiving images. The imaging device receives light signals for image processing in a first operational state and does not receive the light signals for image processing in a second operational state. An electromagnetic detection unit is provided for detecting electromagnetic signals generated by a second imaging system. A synchronization unit is also provided for signaling the imaging device to change operational states in response to a detection of the electromagnetic signals generated by the second imaging system.

The imaging device can change from the first operational state to the second operational state at an approximate time in which a light pulse from the second imaging system is received. The light pulse received from the second imaging system can be defined as a primary light pulse and the electromagnetic signal can be defined as a first light pulse having different characteristics than the primary light pulse. The change can occur at a predetermined time following the detection of the electromagnetic signal. For example, the predetermined time can be a fraction or a multiple of a pulse width of the detected electromagnetic signal, or a time value contained in the detected electromagnetic signal. Further, the imaging device can change from the second operational state to the first operation state at an approximate time in which reception of a light pulse from the second imaging system ends. For example, the imaging system can change to the first operational state after a predetermined time following a change to the second operational state. This predetermined time also can be a fraction or a multiple of a pulse width of the detected electromagnetic signal.

The system can further include at least one light source and at least one electromagnetic source. The light source can emit at least one light pulse and the pulsed electromagnetic source can emit an electromagnetic pulse at a predetermined amount of time prior to the light pulse being emitted.

Although methods and materials similar or equivalent to those described herein can be used in the practice or testing of the present invention, suitable methods and materials are described below. The particular embodiments discussed below are illustrative only and not intended to be limiting. All publications, patent applications, patents, and other references mentioned herein are incorporated by reference in their entirety. In case of conflict, the present specification, including definitions, will control.

### BRIEF DESCRIPTION OF THE DRAWINGS

FIG. 1 is a schematic view of an imaging system for object illumination and imaging in accordance with the present invention.

FIG. 2A is a timing diagram representing illuminating pulses and gating periods associated with an exemplary imaging system in accordance with the present invention.

FIG. 2B is an exploded representation of illuminating pulses of FIG. 2A.

FIG. 3 is a timing diagram representing exemplary pulse pairs of a first imaging system and responsive gate operation of a second imaging system in accordance with the present invention.

### DETAILED DESCRIPTION OF THE PREFERRED EMBODIMENTS

The present invention relates to an imaging system for motor vehicles which emits electromagnetic pulses (primary light pulses) and receives radiation resulting from the primary light pulses being scattered by an object. The scattered radiation received is used for object illumination and imaging. The imaging system also emits a preliminary electromagnetic pulse (first pulse) prior to each primary light pulse to alert other imaging systems that a primary light pulse will soon follow.

The first pulse can have different parameters than the primary light pulse. Accordingly, a first imaging system can receive a first pulse from a second source, such as a second imaging system. In response, the first imaging system can be gated to an operational state where the first imaging system does not responsive to light signals during the time period in which the first imaging system would otherwise receive a blinding primary light pulse emitted by the second imaging system. Accordingly, the first imaging system will not be affected by glare caused by the second imaging system's primary light pulse. Hence, the present invention provides a high reliability imaging system with virtually no glare, which is of utmost importance, especially for vehicles which are used to provide emergency services, such as police vehicles, ambulances, fire rescue vehicles, etc.

Primary Light Pulse Generation and Detection

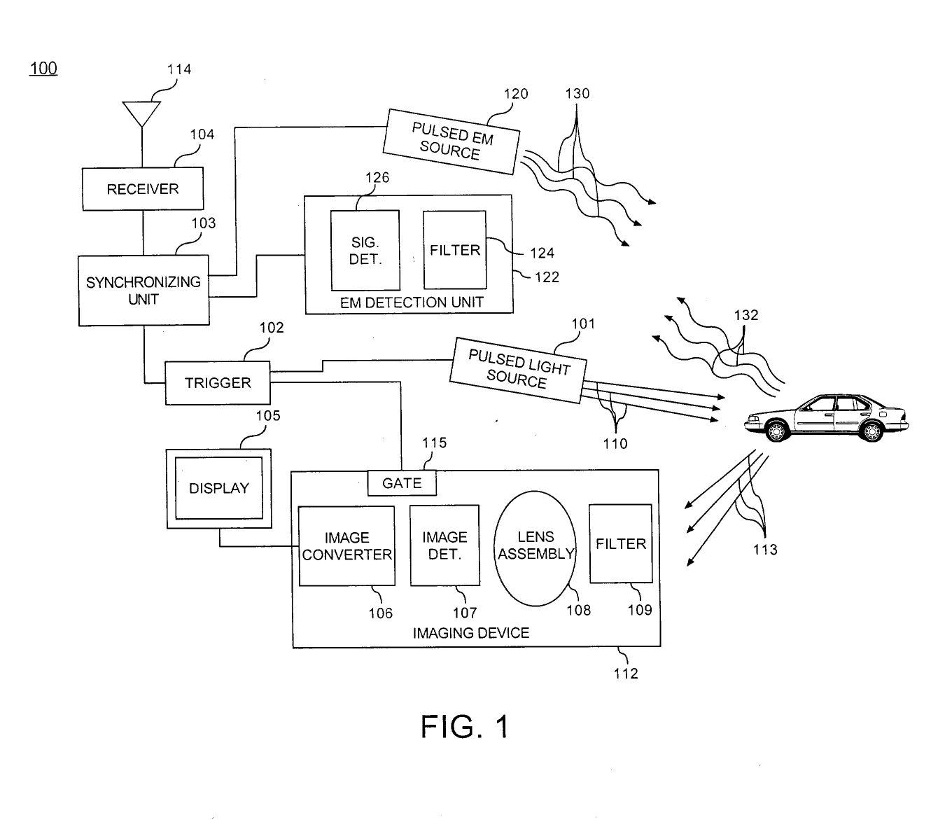

Referring to FIG. 1, a schematic view of an imaging system 100 for object illumination and imaging is shown. The imaging system 100 includes a pulsed light source 101 which can emanate a light pulse 110 which can be scattered by objects to generate scattered light 113. The pulsed light source 101 can be positioned anywhere on a vehicle. For example, in one arrangement the pulsed light source 101 can be configured as a vehicle headlight. In another arrangement, the pulsed light source can be positioned elsewhere on the vehicle, for example on the roof of a vehicle. In yet another arrangement, the pulsed light source can be worn on a human body, for example attached to head gear.

The pulsed light source 101 can be any source of pulsed light which generates light in a spectrum which is visible or invisible to the human eye. For example, the pulsed light source can generate light having a wavelength approximately in the ranges from 0.19 μm to 5 μm. An exemplary pulsed light source can be a laser, a pulsed arc discharge xenon lamp, an electrodeless discharge lamp, a light emitting diode, and other such sources. If a laser generator is used as a pulsed light source 101, its output may be homogenized via a fiber optic, a light pipe, or other such means as known by those skilled in the art to uniformly illuminate a target area.

The light 110 generated by the pulsed light source 101 can be pulsed at any repetition rate. In one arrangement, the light 110 can be pulsed at a repetition rate which is greater than a reciprocal time associated with eye inertia. For example, a repetition rate of 16-24 Hz can be used. Further, the duration of the pulse, or pulse width (ΔT_{PULSE}), can be chosen to be very short, for example several femtoseconds, to rather long, for example several microseconds. In any case, ΔT_{PULSE} should be shorter than about D_{S}/c, where D_{S} is a desired illumination distance in the field of observation for the imaging system 100, and c is the speed of light.

An imaging device 112 can be provided to detect the scattered light 113. For instance, the imaging device 112 can be mounted at or near the front of a vehicle, on the roof of a vehicle, or again worn on the human body (e.g. head mounted). In one arrangement, the imaging device 112 can include a lens assembly 108 and an image converter 106. The imaging device 112 optionally can include an imaging detector 107 which intensifies the scattered light 113 to improve the quality of received images. Further, a light filter 109 also can be provided. The light filter 109 can be colored glass, an acousto-optic filter, a Liot type filter, an atomic resonance fluorescence imaging monochromator, an atomic or molecular magneto-optical (Faraday, Voigt) filter, a low or high resolution interference filter, or any other spectrally selective imaging filter. The light filter 109 can be used to block light which does not have a spectral composition of scattered light 113. Accordingly, only light having the spectral composition of the scattered light 113 can pass through the light filter 109 to the lens assembly 108. The lens assembly 108 can focus the scattered light 113 on the imaging detector 107, or on the image converter 106 if an imaging detector 107 is not provided. In one arrangement, the focal length of the lens assembly 108 can be adjustable to optimize imaging resolution over a range of distances.

The imaging detector 107 can be gated so that it begins receiving image data at the time that the pulsed light source 101 generates a light pulse 110. The imaging device 107 should continue receiving images for a time duration (ΔT_{GATE}), which is approximately equal to about (2D_{S}/c)+ΔT_{PULSE}. Alternatively, the gating period can have a duration approximately equal to the sum of [2(D_{B}−D_{L})/C+ΔT_{PULSE}], where ΔT_{PULSE} is a duration of at least one of said periodic light pulses, D_{L} is a distance correlating to a desired observation range minimum, D_{B} is a distance correlating to a desired observation range maximum, and c is the speed of light.

The time slot can be repeated at fixed times. Accordingly, the imaging device will receive image data only during the optimum light reception time slot, as noted. This mode of illumination also is beneficial when it is desired to increase a number of independent time slots. For example, 40,000 time slots can be provided instead of 20,000. In this case, the area of observation will be in far field, which is further than the area illuminated by low beam headlights. Since the near field area is illuminated by low beam headlights, only part of the distance D_{S} needs to be imaged with the imaging system of the present invention.

The beginning of each time slot can begin, with respect to a time reference, at a time equal to the fixed time multiplied by an integer. In a preferred arrangement, the time slots are short, non-overlapping, time intervals. The time slots can have a predetermined duration and can be reproducible with predefined time shifts with respect to the time reference. For example, if the time slot is to be repeated 25 times per second, the period between pulses can be 40 ms.

Further, at least one instance of a repeating time slot can be timed to begin at a fixed time relative to a synchronization signal, such as a signal providing a time reference. The time reference can be, for example, at 0.000000000 second of every new year, at 0.000000000 second of every Greenwich time new day, at 0.000000000 of each new hour, 0.0000000000 second of every minute, the beginning of each second, or any other suitable time reference.

A gating device 115 can be used to gate the imaging device. In this arrangement, it is preferable that the gating device 115 be fast enough to adequately activate imaging detector 107 reception upon the light pulse being generated and deactivate imaging detector 107 reception after a time slot equal to ΔT_{GATE} has elapsed.

The image converter 106 can capture object images, either directly from the lens 108 or from the imaging detector 107, if provided. For example, the image converter 106 can be a charged coupled device (CCD), a charge injected device (CID) or a compliant semiconductor metal oxide (CMOS) camera which is equipped with corresponding digitizing or analog converter. If the image converter 106 is sensitive enough to detect images without use of the imaging detector 107, then a fast light shutter may be used to gate the image converter 106 so that the image converter 106 will be open approximately during the time slot equal to ΔT_{GATE}. Fast light shutters are known to those skilled in the art, for example a Kerr shutter or a Pockels cell can be used. Pockels cells are commercially available from Cleveland Crystals, Inc. of Highland Heights, Ohio.

Object images converted by the image converter 106 can be forwarded to a display 105 for presentation. The display 105 can be any type of display which can present object images. For example, the display can be a microdisplay, such as a plasma display, a light emitting diode (LED) display, a liquid crystal on silicone (LCOS) display, an organic light emitting diode (OLED) on silicon display, (see S. K. Jones et al., OLED/CMOS Combo Opens a New World of Microdisplay, Laser Focus World, December 2001, at 55-58), a cathode ray tube (CRT), and other suitable displays. The display also can be a display which is worn by a driver of a vehicle, such as display goggles, or the display can be a heads-up display, for instance where images are projected onto a windshield of a vehicle. If display goggles, or any other type of head-mounted display is used, a stereoscopic image of the road can be obtained by using two imaging devices, one on each side of a vehicle. Accordingly, separate images can be generated for each side of the vehicle. Accordingly, images from the left side of the vehicle can be transmitted to the left eye and images from the right side of the vehicle can be transmitted to the right eye.

A trigger 102 can control the gate timing of the image converter 106 and/or the imaging detector 107, if provided. The trigger 102 can be operatively connected to a synchronizing unit 103. The synchronizing unit 103 can include synchronization circuitry for maintaining time synchronization. Further, the synchronization unit 103 can include a processor for executing software algorithms, and a data storage upon which data and software programs can be stored.

The synchronizing unit 103 can provide a synchronizing signal to insure that the trigger 102 simultaneously activates the pulsed light source 101 and the gating device 115, thereby keeping the pulsed light source 101 synchronized with the image converter 106 and/or the imaging detector 107. For instance, if a laser is used as the pulsed light source, the synchronizing signals can be used to trigger a Q-switch element associated with the laser. If the laser is activated by a second laser, such as pulsed semiconductor laser or a pumping laser, the synchronizing signals can be used to trigger the second laser.

A receiver/timing signal processor (receiver) 104, which is operatively connected to an antenna 114, antenna array or satellite dish, can be provided. The receiver 104 can receive radio frequency (RF) timing signals and provide these signals to the synchronizing unit 103 for use in timing the pulsed light source 101 and the gating device 115. For example, the synchronizing unit 103 and/or receiver 104 can include an internal oscillator and software algorithms that process the RF timing signals. There are a number of timing signal references from earth based time stations that can be used. In one example, the RF timing signals can be timing signals received from either of the National Institute of Standards and Technology (NIST) time stations near Fort Collins, Colo. (WWV and WWVB) or the NIST time station in Kauai, Hi. (WWVH). The timing signals transmitted by WWV and WWVH are specified as having a tolerance which is less than one microsecond at the transmitter site with reference to Coordinated Universal Time (UTC). Over the last several years, however, the timing signals have measured to be within fifty nanoseconds of UTC. Timing signals also can be obtained from a Wide Area Augmentation System (WAAS) which is commonly used to provide precision guidance to aircraft. Further, timing signals also can be proved in desired geographic regions, such as large metropolitan areas, with the use of a local positioning system. A local positioning system can comprise three or more local transmitters which can emanate RF signals carrying timing information and data from which coordinates can be determined.

In another example, the RF timing signals can be timing signals received via a modern Global Positioning Satellite (GPS) receiver, which can provide even greater time synchronization precision. For instance, RF timing signals can be received from the United States GPS system, the Russian Global Navigation Satellite System (GLONASS), and/or any another global positioning system. Modern GPS receivers can produce time synchronization with a standard deviation of ten nanoseconds or less. Such receivers are available from a number of commercial providers, such as TrueTime, Inc. of Santa Rosa, Calif. Further, methods for using GPS or GLONASS to achieve sub-nano second precision are known, for example as disclosed by Wlodzimierz Lewandowski of Jacques Azoubib Bureau International des Poids et Mesures in an article entitled GPS+GLONASS: Toward Subnanosecond Time Transfer, GPS World, vol. 9, at 30-39 (1998). The use of GPS or GLONASS also can have the added benefit of providing vehicle location and tracking information. The use of GPS and GLONASS for providing vehicle location and tracking information is known to those skilled in the art.

In operation, imaging systems which are installed in vehicles can generate and receive uniquely timed light pulses. Accordingly, light pulses generated by a first vehicle will not overlap with light pulses generated by a second vehicle, and thus will not arrive at the second vehicle while the second vehicles imaging detector is activated to receive light. Likewise, in the case that the second vehicle uses a gated image converter in lieu of an imaging detector, light pulses from the first vehicle will not arrive to the second vehicle while the shutter of the gated image converter in the second vehicle is open. Accordingly, the amount of light received from other vehicles can be minimized, thereby reducing glare caused by the lights of other vehicles.

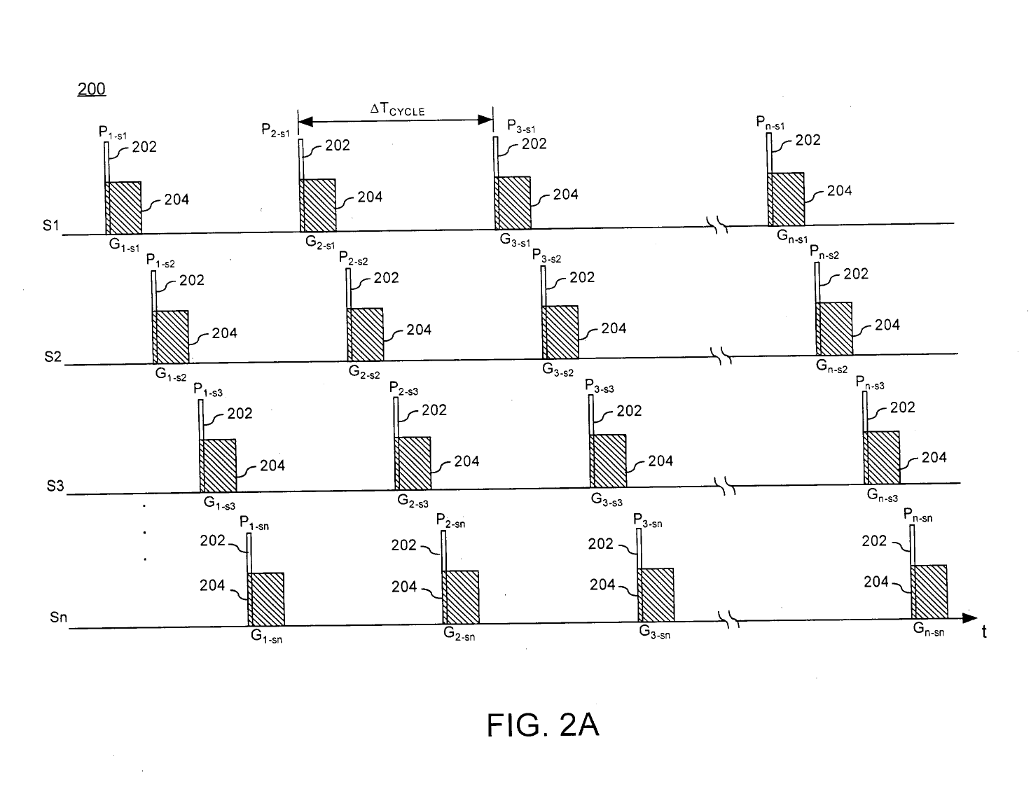

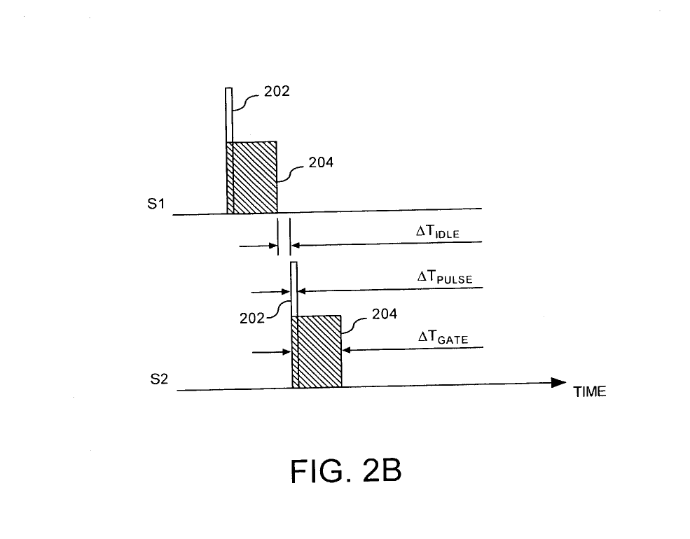

A diagram representing an exemplary pulse timing chart 200 is shown in FIG. 2A. The timing chart 200 displays a plurality of light pulse streams S₁, S₂, S₃, Sₙ, each of which can represent the uniquely timed light pulses 202 generated by a different imaging system. The pulse streams S₁, S₂, S₃, Sₙ can be synchronized using a time reference 206, such as an RF timing signal. The pulse timing chart 200 also shows the gating period (ΔT_{GATE}) 204 associated with each pulse 202. For instance, pulse stream S₁ includes light pulses P₁₋ₛ₁, P₂₋ₛ₁, P₃₋ₛ₁, Pₙ₋ₛ₁ and gating periods G₁₋ₛ₁, G₂₋ₛ₁, Gₙ₋ₛ₁, pulse stream S₂ includes light pulses P₁₋ₛ₁, P₂₋ₛ₂, P₃₋ₛ₂, Pₙ₋ₛ₂ and gating periods G₁₋ₛ₂, G₂₋ₛ₂, G₃₋ₛ₂, Gₙ₋ₛ₂, and so on. As noted, each gating period can begin when the pulse with which the gating period is associated begins.

Referring to FIGS. 2A and 2B, the time that elapses between the end of a gating period for a particular light pulse and the beginning of a next light pulse being generated, such as a light pulse generated in another light pulse stream, can be referenced as idle time (ΔT_{IDLE}). Accordingly, the duration of one time slot (ΔT_{Z}) can be defined as ΔT_{Z}=ΔT_{GATE}+ΔT_{IDLE}. Further, the time for one complete cycle in a light pulse stream can be defined as ΔT_{CYCLE}, where ΔT_{CYCLE} can be measured as the time elapsing between the start time of a first light pulse and the start time of a second light pulse in the same light pulse stream. Ideally, assuming one pulse stream can operate in each time slot, the maximum number (N_{S}) of pulse streams that can operate without an overlap of gating periods can be determined by the number of time slots available. The number of time slots available can be determined by the formula N_{S}=ΔT_{CYCLE}/ΔT_{GATE}. However, this formula assumes absolutely precise synchronization of light pulses and gating of the imaging detector and/or imaging converter. Alternatively, the equation N_{S}=ΔT_{CYCLE} /(ΔT_{GATE}+ΔT_{IDLE})=ΔT_{CYCLE}/ΔT_{Z} can be used to determine the maximum number of time slots, thereby allowing for variations in timing signals and synchronization among imaging systems. For example, if ΔT_{GATE}=1-2 μs, an appropriate value for ΔT_{IDLE} may be 100-400 ns. Nonetheless, it may be more desirable to make ΔT_{GATE} and ΔT_{IDLE} much shorter to maximize N_{S}. For instance, if ΔT_{CYCLE} is 50 ms and ΔT_{Z}=5 μs, 1×10⁴ time slots are provided and 1×10⁴ pulse streams can operate without overlap of gating periods. If ΔT_{CYCLE} is 50 ms and ΔT_{Z}=2.5 μs, 2×10⁴ time slots are provided and 2×10⁴ pulse streams can operate without overlap of gating periods. Assuming an operational range D_{S} of 300 m, ΔT_{CYCLE}=50 ms, ΔT_{PULSE}=50 ns and ΔT_{IDLE}=10 ns, 2.42×10⁴ time slots can be provided. Notably, ΔT_{PULSE} can be even shorter, for example as short as 10 ns.

It may appear that a pulse width ΔT_{PULSE} of 10 ns would not give adequate image quality because for every second of operation only 200 ns of image data for a particular point in a road is received, assuming ΔT_{CYCLE} is 50 ms. However, the distance of effective illumination does not correlate to pulse width. Accordingly, a series of images which are received with a repetition rate of at least 16-20 images per second will appear like a continuous image stream, even if each image gating period ΔT_{GATE} is extremely short.

Additionally, short light pulses and short gating periods which are time shifted with respect to the light pulses can be used to improve visibility of objects or a roadway when the visibility is deteriorated due to clouds, fog, dust, or any other airborne molecules or particulates which can scatter light (hereinafter referred to as particulates). In operation, the short gating periods can be used to reduce or eliminate the reception of light which has been scattered by the particulates. In particular, the gate can be timed to close immediately after receiving light scattered by objects being illuminated, but before significant radiation from light scattered by the particulates is received. In consequence, the use of short light pulses and gating periods can provide much higher image quality when airborne particulates are present. For example, a pulse duration (ΔT_{PULSE}) which is less than D_{S}/c can be advantageous.

In another example, let it be assumed that a first imaging system is operating in a first vehicle and specified to illuminate a region in front of the first vehicle for a distance (D_{S}) of 300 m. Also assume the light pulses are synchronized with the UTC. Accordingly, the gating period ΔT_{GATE} for the first vehicle should be (2×300)/(3×10⁸)=2×10⁻⁶. Further assume that the imaging system generates a light pulse having a duration ΔT_{PULSE}=100 ns and a repetition rate (R_{c}) of 25 Hz. Further, assume that the idle period ΔT_{IDLE} is significantly shorter than the gating period ΔT_{GATE} so that the time slot ΔT_{Z} is approximately equal to ΔT_{GATE}. Accordingly, the probability (Pₘ) of the first vehicle meeting an oncoming second vehicle which emanates light pulses during the gating period of the first vehicle is given by the equation Pₘ=ΔT_{GATE}R_{c}=(2×10⁻⁶) ×25=5×10⁻⁵ In other words, approximately one out of 20,000 cars will emanate a light pulse which may be detected by the first illumination system during the gating period.

Next, assume that R_{M} is the average rate of the first vehicle encountering a second vehicle which has the same type of illuminating system and which operates in a randomly selected time slot. Further, assume that T_{TR} represents the amount of time the first vehicle is being operated on the road. Accordingly, the probability (Pₘ) of the imaging system of the first vehicle receiving significant glare at least once from light pulses of the second vehicle can be estimated by the equation Pₘ=ΔT_{Gate}R_{c}T_{TR}R_{M}, where Pₘ<1. Hence, the likelihood of a vehicle receiving significant glare from another vehicle's illumination system is extremely low.

In contrast, if the pulses are not synchronized into time slots, such as those synchronized with UTC, the equation for the probability (Pₘ) of a first vehicle receiving significant glare from an oncoming second vehicle will be different. In this case, the probability Pₘ should be multiplied by the number of pulses (N_{P}) emanated by the second vehicle as it approaches the first vehicle. N_{P} can be determined by equation N_{P}=[D_{S}/(v₁+v₂)] R_{c} (where v₁+v₂ is the mutual velocity of two cars towards each other). Depending on the mutual velocity of cars, N_{P} may vary. For example, assume that D_{S}=250 m, v₁=20 m/s, v₂=10 m/s and R_{c}=50 Hz. In this example N_{P}=416. Hence, in comparison to a situation when two approaching vehicles emit light pulses in pre-defined time slots, the probability of glare increases significantly when pre-defined, synchronized time slots are not used. Accordingly, the use of a timing signal for pulse synchronization substantially decreases the probability of an imaging system receiving glare from an imaging system of an oncoming vehicle.

Imaging Detector Considerations

The Doppler effect caused by vehicles moving toward each other is preferably considered when implementing the present invention. In particular, the minimal detection bandwidth which is required for the imaging detector 107 to detect a particular frequency of light can be estimated from the amount of frequency shift that is likely to occur due to the Doppler effect (Doppler shift). The Doppler shift can be determined by the equation Δv=2v (V/c)=2V/λ, where v is the frequency of the light, Δv is the change in frequency of the light, V is the relative velocity of the vehicles with respect to each other, and λ is the wavelength of the light. For example, if the maximum velocity of each of two vehicles as they approach each other is 50 mph, the relative velocity between the vehicles is V=100 mph (44.7 m/s) since the cars are moving toward each other. If the wavelength (λ) of the light pulses emanated by a first vehicle are 700 nm, the Doppler shift Δv associated with those light pulses computes to be 127.7 MHz. If the wavelength (λ) of the light pulses emanated are 1500 nm, the Doppler shift Δv is 59.6 MHz. Further, the Fourier transform of short light pulses can be evaluated and taken into consideration. Accordingly, for this example, a detection bandwidth of 100 MHz-300 MHz will be adequate if pulses with duration 1-10 ns are used.

The resolution R of an imaging detector is equal to λ/Δλ, where λ is the wavelength of the light pulses being detected and Δλ is variation in wavelength due to Doppler shift. It is preferable that the imaging detector have a resolution of approximately R=c/2V or 3.35×10⁶ in the example. Further expanding the example, if the area of the imaging detector is approximately 3-5 cm² and the field of view is 1-2 steradians (sr), it can be estimated that the ideal luminosity-resolving power product (LRPP) for imaging a moving object using a very narrowband light pulse is approximately 10⁷-10⁸ cm² sr. A number of imaging detectors which provide the necessary LRPP are currently known to those skilled in the art.

In one arrangement, the imaging detector can be a resonance ionization imaging detector (RIID). A suitable RIID is disclosed in U.S. Pat. No. 6,008,496 to Winefordner et al., which is incorporated herein by reference. When a RIID is used, the RIID can be activated to detect images when the atoms of an atomic vapor in an RIID cell are excited into their Rydberg states. To decrease or eliminate the RIID noises, atoms can be excited into Rydberg states with a lifetime which is more than 2D_{S}/c. In the case, a high voltage pulse, for example 1-50 kV, can be applied when the λ₂ pulse is ended. To excite the atoms into their Rydberg states, the atomic vapor can be illuminated by a trigger light source which emanates light having a wavelength of λ₂. For example, if Cs is used for the atomic vapor, the wavelength λ₂ can be about 535 nm −510 nm to excite one or several Rydberg states.

When in its ground state, the atomic vapor absorbs light which has a wavelength tuned to the resonance transition of the atomic vapor. Within the RIID, a laser with a predetermined wavelength can illuminate the atomic vapor to excite the atomic vapor into Rydberg states. An electric field pulse or additional laser radiation then can be applied to the atoms excited into the Rydberg states, thereby producing free electrons and ions. As a result of selective ionization of atoms in the RIID cell, the free ions and electrons can be created and accelerated by an electric field towards the RIID screen, which can have a phosphor coating, or any other high energy electron sensitive screen to produce an image. Alternatively, the free electrons or ions can be accelerated towards an imaging signal amplifier, such as microchannel plate. In such an arrangement, free electrons from the microchannel plate can be directed to strike the screen.

Hence, the pulsed light source 101 can generate narrow band light pulses which are tuned to an appropriate resonance transition for the atomic vapor within the RIID cell. For example, cesium (Cs) vapor has resonance transitions of 894.35 nm and 852.11 nm, rubidium (Rb) has resonance transitions of 794.76 nm or 780.02 nm, potassium (K) has resonance transitions of 769.90 nm or 766.49 nm and mercury (Hg) has a resonance transition of 253.7 nm and a non-resonance transition 438.5 nm. In order to effectuate the gating action in the RIID, the trigger light source can be pulsed for a length of time equal to about ΔT_{GATE}. It should be noted that any other atomic or molecular vapor which can selectively absorb specific frequencies of light can be used and the present invention is not so limited.

RIID cells are susceptible to noise caused by nonselective multiphoton ionization of atoms and molecules due to the photo electric effect from the RIID surfaces. To eliminate the noise, a first voltage pulse can be applied to electrodes of the RIID cell in order to remove all noise electrons and ions after the gate is closed. For a RIID cell without micro channel plate (MCP), the pulse duration can be about 10 ns -500 ns and this voltage may be about 10 V-1000 V. Such a voltage pulse is not high enough to ionize the atoms of the atomic vapor which have been excited into the Rydberg state. A second voltage pulse of about 1000 V up to 50 kV can be applied to ionize the atoms which have been excited into the Rydberg state. This second voltage pulse can accelerate electrons or ions toward a screen or other imaging detector which is sensitive to charged particles, thereby producing an image of detected objects. The atoms which have been excited into the Rydberg state may also be ionized after the gate is closed by applying a delayed pulsed laser radiation, for example a 1064 nm Neodymium:Yttrium/Aluminum/Garnet (Nd:YAG) laser.

Notably, the RIID can provide spectral selection since the atomic vapor absorbs fairly narrow bands of light which correspond to the resonance transitions. For example, the RIID can have a selection bandwidth can be approximately from 200 MHz up to 1 GHz. Accordingly, filter 109 is not required if a RIID is used, which can be very beneficial since filters are usually limited as to the amount of LRPP. For example, filters such as acoustooptic filters, can pass a maximum LRPP of approximately 3×10³ cm² sr. As noted, the RIID has a much greater value of LRPP, which reduces image distortions, noise and glare from oncoming vehicles, thereby providing images with higher quality.

The ability of the RIID to process images from light which has a very narrow frequency bandwidth provides further advantages. For example, the probability of a first vehicle having a first imaging system receiving glare from a second vehicle having a second imaging system can be reduced by operating the first and second imaging systems at different frequencies. Accordingly, the first imaging system can be configured so that light pulses emanating from the second imaging system are not detectable by the first imaging system, and vice versa. In this manner, different light pulses can be used by different groups of vehicles to expand the number of vehicles that can use the imaging systems without excess glare being generated. If, for example, the imaging device has a bandwidth approximately 300 MHz, and the center frequency has a wavelength anywhere in the spectral range 1.52 μm-1.76 μm, almost 90,000 independent spectrally separated channels may be provided to decrease the probability of the imaging system receiving glare from oncoming vehicles. Thus, combining spectral selection with time slot allocation substantially decreases the probability of an imaging system receiving glare from an imaging system in another vehicle. Combining the above spectral selection example with our previous time slot example, the total probability of encountering a vehicle operating with an imaging system operating in the same time slot and at the same wavelength will be 1/(90,000×20,000)=5.55×10⁻¹⁰. Notably, the reciprocal number of this probability is at least three orders of magnitude greater than total number of cars on the Earth.

At this point it should be noted that other imaging detectors can be used and the invention is not limited to a RIID. For example, the imaging detector can be an atomic and/or molecular vapor ultranarrowband imaging detector, as described in O. I. Matveev et al., Narrow-band resonance-ionization and fluourescence imaging in a mercury-vapor cell, Optics Letters, Vol. 23, no. 4, at 304-06 (1998). An atomic and/or molecular magnetooptical filter also can be used also can be used as an imaging detector. (See, e.g., B. Yin et al., Theoretical Model for a Faraday Anomalous Dispersion Optical Filter, Optics Letters, Vol.16, no. 20 at 1617-19 (1991). See also, R. I. Billmers et al., Experimental Demonstration of an Excited-state Faraday Filter Operating at 532 nm, Optics Letters, Vol. 20, no.1 at 106-08 (1995); E. Dressler et al., Theory and Experiment for the Anomalous Faraday Effect in Potassium, Journal Optical Society of America, Vol. 13, no. 9 at 1849-58 (1996); B. P. Williams et al., Magneto-optic Doppler Analyser: A New Instrument to Measure Mesopause Winds, Applied Optics, Vol. 35, no. 33 at 6494-6503 (1996)). Further, a spectral hole burning filter also can be used. (See, e.g., W. E. Moerner, Persistent Spectral Hole-Burning: Science and Applications, Springer Verfag, Berlin (1988); B. S. Ham et al., Enhanced Nondegenerate Four-Wave Mixing Owing to Electromagnetically Induced Transparency in a Special Hole-Burning Crystal, Optics Letter, Vol. 22, no.15 at 1138-40 (1997); H. Hemmati, Narrow-band Optical Filters Made by Spectral Hole-Burning, NASA Tech Brief, August, 1997 at 54; A. Rebane, Femtosecond Time-And-Space-Domain Holography, Trends in Optics, Academic Press at 165-88 (1996); K. Fujita et al., Room Temperature Persistent Spectral Hole Burning of Eu 3+in Sodium Alumosislicate Glasses, Optics Letters, Vol. 23, no. 7 at 543-45 (1998)).

Regardless of the type of imaging detector which is used, images captured by the imaging detector can be utilized for any number of purposes. For example, as noted, the images can be presented on a display. The images also can be stored to a storage medium. For example, the images can be stored to a hard disk drive, a video tape, a digital video disk, or any other suitable storage suitable for storing images. Accordingly, the images can be available for viewing and analysis at a later time. The images also can be analyzed in real-time using an image processing system. For instance, the images can be analyzed and processed as part of an accident warning or accident avoidance system. Still, the images can be used for other purposes and the present invention is not so limited.

Preliminary Pulse Notification

Reliability for the imaging system is of utmost importance, especially for vehicles which are used to provide emergency services, such as police vehicles, ambulances, fire rescue vehicles, etc. To increase reliability of imaging systems, an additional pulse generator can be provided with the imaging systems to generate a preliminary electromagnetic pulse (first pulse) which has a different frequency than the light pulse (primary light pulse). As defined herein, an electromagnetic pulse can be any electromagnetic signal having any wavelength in the electromagnetic spectrum. However, if it is desired to focus the electromagnetic waves in a particular direction, electromagnetic waves from the microwave spectrum through the ultra-violate (UV) spectrum are more easily focused than longer electromagnetic waves.

The first pulse can be emitted before the primary light pulse is emitted. The first pulse can be generated using a pulse allocation system similar to the one previously described and can be directed in the same direction as the primary light pulse. Accordingly, a first imaging system can be notified by the first pulse that a primary light pulse will soon be arriving from a second imaging system. In response to receiving the first pulse, an image detector, or image converter, in the first imaging system can be gated to the off position so that it does not receive images and/or process received images throughout the duration of the primary light pulse emanated by the second imaging system. Accordingly, the primary light pulse will not cause glare for oncoming imaging systems. This embodiment can be referred to as an ultra fast synchronized imaging (UFSI) technology.

Referring again to FIG. 1, the imaging system 100 can include a pulsed electromagnetic source 120 for emitting a first pulse 130. The type of electromagnetic source 120 which is used to generate the first pulse 130 will be dependent on the frequency or wavelength of the first pulse 130 being generated. Although the first pulse 130 can be generated using any electromagnetic frequency, pulses in the microwave or light frequency spectrum have a narrow lobe pattern and can be advantageous if it is desired to focus the first pulse in a particular direction. If it is desired that the first pulse be in the UV, visible or infrared region of spectrum, the electromagnetic source 120 can be, for example, a horn antenna. If it is desired that the first pulse be in the light spectrum, the electromagnetic source can be a laser, a pulsed arc discharge xenon lamp, an electrodeless discharge lamp, a light emitting diode, and so on. It is generally preferred that the pulse not be in the visible light spectrum, however. Moreover, the first pulse 130 should be spectrally distinct from the primary light pulse 110 so as not to cause interference with the imaging device 112. For example, the first pulse 130 can operate at a different frequency or wavelength than the primary light pulse 110.

Each imaging system 100 also can include an electromagnetic detection unit (detection unit) 122. The detection unit 122 can include a wavelength selective filter 124 and a signal detector 126. The signal detector 126 can be a suitable detector which can detect signals such as the first pulse. For example, the signal detector can be an radio frequency (RF), microwave or photon signal detector. The filter 124 can be any spectrally selective filter which passes electromagnetic signals having the spectral frequency of the first pulse 130. For example, if the first pulse is in the RF spectrum, the filter 124 can be an RF filter. If the first pulse is in the microwave frequency spectrum, the filter 124 can be a microwave filter. If the first pulse is in the light frequency spectrum, the filter 124 can be a light filter, such as colored glass, an acousto-optic filter, a Liot type filter, an atomic resonance fluorescence imaging monochromator, an atomic or molecular magneto-optical (Faraday, Voigt) filter, a low or high resolution interference filter, etc.

The detection unit 122 and the filter 124 can be communicatively connected to a synchronizing unit 103, as well as the trigger 102. As noted, the synchronizing unit can provide a synchronizing signal to insure that the trigger 102 simultaneously activates the pulsed light source 101 and the gate of the image converter 106 and/or the image detector 107, thereby keeping the pulsed light source 101 synchronized with the image converter 106 and/or the image detector 107. Further, upon receiving a first pulse 132 emanated by another UFSI system, for example a second UFSI system in a second oncoming vehicle, the synchronizing unit 103 can provide a first pulse detection signal to the trigger 102. In response, the trigger 102 can cause the gate 115 to cease image detection by the image converter 106 and/or the image detector 107 (if provided) to prevent a primary light pulse emanated by the second UFSI system from being processed by the image converter 106. Accordingly, glare caused by a primary light pulse emanated by the second UFSI system is minimized.

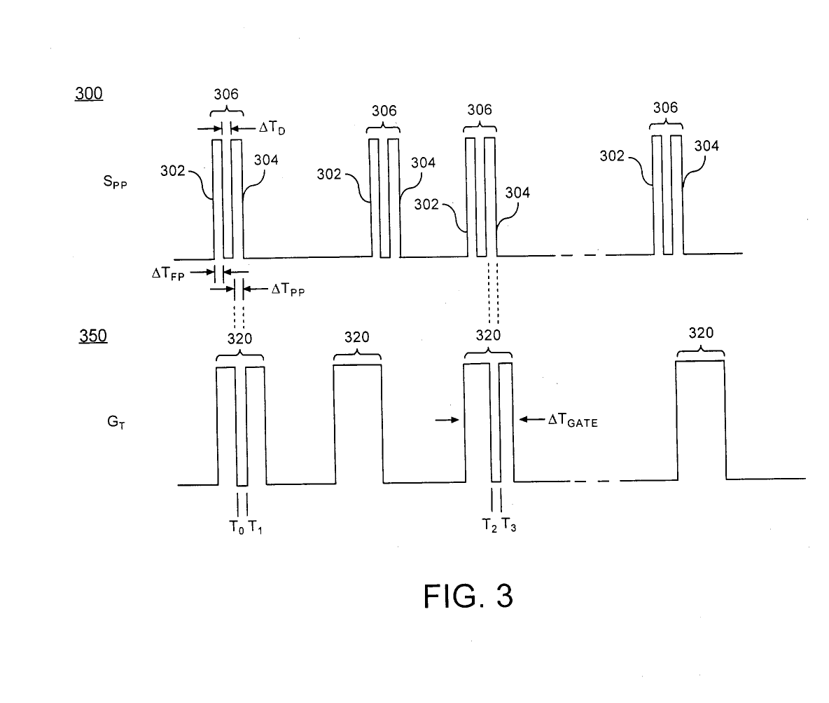

A diagram 300 representing an exemplary pulse stream S_{PP} and a diagram 350 representing an exemplary gate timing stream G_{T} for the preliminary pulse notification are shown in FIG. 3. The pulse stream S_{PP} includes a plurality of first pulses 302 and a plurality of primary light pulses 304 which are emanated by a second UFSI system. Each first pulse 302 and the immediately following primary light pulse 304 represent a pulse pair 306. ΔT_{D} can represent the time interval between the end of the first pulse 302 and the beginning of the primary light pulse 304 of each pulse pair 306. The reference time scale for the pulse stream S_{PP} is based upon a time of reception of the first pulse 302 by a first UFSI system.

The gate timing stream G_{T} represents the gating operation of the image converter and/or image detector of the first UFSI system. Gate timing can be controlled so that image reception is halted for each time period ΔT_{PP} correlating to the pulse width of primary light pulse 304, and hence the approximate duration of potential reception of the primary light pulses 304 by the first UFSI system. For example, if reception of a primary light pulse begins at T₀ and ends at T₁, image reception in the first UFSI system can be halted at T₀ and resumed at T₁. Likewise, image reception can be halted at T₂ and resumed at T₃. This process can be repeated each time that a possible reception time of a primary light pulse from the second UFSI system coincides with the first UFSI system's gating period.

For proper timing of the gating operation, the first UFSI system should have knowledge of ΔT_{D} and ΔT_{PP}. For example, in one arrangement, ΔT_{D} and ΔT_{PP} can be constant values common to multiple UFSI systems. In another exemplary arrangement, the values of ΔT_{D} and ΔT_{PP} can be transmitted from the second UFSI system to the first UFSI system. In yet another example, ΔT_{D} and ΔT_{PP} each can be a fraction or multiple of the pulse width ΔT_{FP} of the first pulse. For instance, the first UFSI system can measure the pulse width ΔT_{FP} while the first pulse is being received and ΔT_{D} and ΔT_{PP} values can be computed accordingly. Nonetheless, the invention is not so limited and any arrangement wherein the first UFSI system has knowledge ΔT_{D} and/or ΔT_{PP} is within the intended scope of the present invention.

Since image reception by the first UFSI system is turned off during reception of the primary light pulse 304 generated by the second UFSI system, it may be advantageous for the pulse width ΔT_{PP} of the primary light pulse 304 to be minimized. For example, if the first vehicle is traveling on a road at a velocity of 20 m/s, the pulse width ΔT_{PP} is 1 ns, the gating period ΔT_{GATE} is 1 μs, the gating repetition rate R_{c} for the first UFSI system is 25 Hz, and the range of operation of the first UFSI system is 300 m. In this example, only a total of 15 cm of roadway in the 300 m operational range will be partially invisible to the first UFSI system, which is insignificant. If a pulse width ΔT_{PP} of 10 ns is used, only 1.5 m of roadway will be partially invisible. With a pulse width ΔT_{PP} of 300 ns is used, 45 m of roadway will be partially invisible, which is probably acceptable considering this is only 15% of the operational range of the UFSI system.

In another arrangement, the timing in which each pulse pair 306 is emanated by the second UFSI system can be varied, for instance so that the pulse pairs 306 are generated quasi-synchronously. For example, the pulse pairs can be generated at a frequency which is intentionally varied by a certain amount, for example from −5% to +5%. Accordingly, the probability of the gating period 320 overlapping with the primary light pulses 304 can be minimized. The probability of the first UFSI system receiving glare from the second UFSI system is given by the equation

$${P}_{m} = Δ {T}_{GATE} {R}_{c}^{2} \frac{{D}_{s}}{{V}_{c}} {T}_{TR} {R}_{M} ,$$

where V_{C} is the relative velocity of vehicles approaching each other and D_{S} is the distance from which significant glare from a UFSI system can be detected. As noted, R_{M} is the average rate of a first vehicle having the UFSI system encountering a second vehicle which has the same type of illuminating system and which operates in a randomly selected time slot, and T_{TR} represents the amount of time the first vehicle is being operated on the road.

Further, the probability S_{AV} of a first UFSI system receiving at least one primary light pulse from another UFSI system within one time frame when image intensifier is supposed to detect image of the road is S_{AV}=ΔT_{GATE}R_{C}N_{C}, where N_{C} is a number of oncoming vehicles producing primary light pulses. If the reception of primary light pulses are considered a random event, the probability P_{D} of a UFSI system receiving a X number of primary light pulses (X=1, 2, 3 . . . etc) during a gating period ΔT_{GATE} can be determined by the Poisson probability distribution formula

$${P}_{D} = \frac{{S}_{AV}^{X} exp ( - {S}_{AV} )}{X !} .$$

Although multiple embodiments of the invention have been described in detail for purposes of illustration, various modifications may be made without departing from the spirit and scope of the invention. Importantly, examples provided in this specification are provided for illustration only and are not to be construed as limiting the scope or content of the invention in any way. Accordingly, the invention is not to be limited except as by the appended claims.

We claim:

1. A reduced glare imaging system for motor vehicles, comprising:
at least one imaging device for receiving images, said imaging device being operational between a first operational state wherein said imaging device receives light signals for image processing and a second operational state wherein said imaging device does not acquire said light signals for image processing;
at least one electromagnetic detection unit for detecting electromagnetic signals generated by a second imaging system; and
a synchronization unit for signaling said imaging device to change operational states in response to a detection of said electromagnetic signals generated by said second imaging system.

2. The system of claim 1, wherein said imaging device changes from said first operational state to said second operational state at an approximate time in which a light pulse from said second imaging system is received.

3. The system of claim 1, wherein said imaging device changes from said first operational state to said second operational state at a predetermined time following said detection of said electromagnetic signal.

4. The system of claim 3, wherein said light pulse received from said second imaging system is defined as a primary light pulse and said electromagnetic signal is defined as a first light pulse having different characteristics than said primary light pulse.

5. The system of claim 3, wherein said light pulse received from said second imaging system is defined as a primary light pulse and said electromagnetic signal is defined as a first light pulse having a different wavelength than said primary light pulse.

6. The system of claim 3, wherein said predetermined time is at least one of a fraction and a multiple of a pulse width of said detected electromagnetic signal.

7. The system of claim 3, wherein said predetermined time is a time value contained in said detected electromagnetic signal.

8. The system of claim 1, wherein said imaging device changes from said second operational state to said first operation state at an approximate time in which reception of a light pulse from said second imaging system ends.

9. The system of claim 1, wherein said imaging device changes from said second operational state to said first operational state after a predetermined time following a change to said second operational state.

10. The system of claim 9, wherein said predetermined time is at least one of a fraction and a multiple of a pulse width of said detected electromagnetic signal.

11. The system of claim 1, further comprising at least one light source and at least one electromagnetic source, wherein said light source emits at least one light pulse and said pulsed electromagnetic source emits an electromagnetic pulse at a predetermined amount of time prior to said light pulse being emitted.

12. A method of providing reduced glare imaging, comprising the steps:
defining a first operational state for an imaging device wherein said imaging device receives light signals for image processing and a second operational state for said imaging device wherein said imaging device does not receive said light signals for image processing;
defining parameters of at least one type of electromagnetic signal; and
changing said operational states of said imaging device in response to a detection of an electromagnetic signal generated by a second imaging device which meets said defined parameters.

13. The method of claim 12, further comprising the step of changing said imaging device from said first operational state to said second operational state at an approximate time in which a light pulse from a said imaging system is received.

14. The method of claim 12, further comprising the step of changing said imaging device from said first operational state to said second operational state at a predetermined time following said detection of said electromagnetic signal.

15. The method of claim 14, further comprising the step of defining said light pulse received from said second imaging system as a primary light pulse and defining said electromagnetic signal as a first light pulse having different characteristics than said primary light pulse.

16. The method of claim 14, further comprising the step of defining said light pulse received from said second imaging system as a primary light pulse and defining said electromagnetic signal as a first light pulse having a different wavelength than said primary light pulse.

17. The method of claim 14, further comprising the step of defining said predetermined time to be at least one of a fraction and a multiple of a pulse width of said detected electromagnetic signal.

18. The method of claim 14, further comprising the step of defining said predetermined time as a time value contained in said detected electromagnetic signal.

19. The method of claim 12, further comprising the step of changing said imaging device from said second operational state to said first operation state at an approximate time in which reception of a light pulse from said second imaging system ends.

20. The method of claim 12, further comprising the step of changing said imaging device from said second operational state to said first operational state after a predetermined time following a change to said second operational state.

21. The method of claim 20, further comprising the step of defining said predetermined time to be at least one of a fraction and a multiple of a pulse width of said detected electromagnetic signal.

22. The method of claim 12, further comprising the step of emitting an electromagnetic pulse at a predetermined amount of time prior to emitting a light pulse.
